(19) United States
(12) Patent Application Publication
(10) Pub. No.: US 2025/0322555 A1
(43) Pub. Date: Oct. 16, 2025

(54) INTERMEDIATE NOISE RETRIEVAL FOR IMAGE GENERATION

(71) Applicant: ADOBE INC., SAN JOSE, CA (US)

(72) Inventors: Shubham Agarwal, West Bengal (IN); Subrata Mitra, Bangalore (IN); Srikrishna Karanam, Bangalore North (IN); Koyel Mukherjee, Bangalore (IN); Shiv Kumar Saini, Bangalore (IN)

(21) Appl. No.: 18/637,024

(22) Filed: Apr. 16, 2024

(51) Int. Cl. G06T 11/00; G06T 1/60; G06T 5/60; G06T 5/70

(52) U.S. Cl. CPC G06T 11/00; G06T 1/60; G06T 5/60; G06T 5/70; G06T 2207/20081

(57) ABSTRACT

A method, apparatus, non-transitory computer readable medium, apparatus, and system for image processing include obtaining an input prompt and retrieving an intermediate noise state based on a similarity between the input prompt and a candidate prompt corresponding to the intermediate noise state. An image generation model generates a synthetic image based on the input prompt and the intermediate noise state.

### BACKGROUND

The following relates generally to image processing, and more specifically to image generation using machine learning. Machine learning models may be used for a variety of image processing tasks including image editing and image generation. A variety of machine learning models may be used for image processing, including generative adversarial networks (GANs), variational auto-encoders (VAEs) and diffusion models. However, in some cases, machine learning models used for image processing may be computationally intensive. Therefore, there is a need in the art for more computationally efficient image processing models.

### SUMMARY

A method, apparatus, and non-transitory computer readable medium for image generation are described. One or more aspects of the method, apparatus, and non-transitory computer readable medium include obtaining an input prompt, retrieving an intermediate noise state based on a similarity between the input prompt and a candidate prompt corresponding to the intermediate noise state, and generating, using an image generation model, a synthetic image based on the input prompt and the intermediate noise state.

A method, apparatus, and non-transitory computer readable medium for image generation are described. One or more aspects of the method, apparatus, and non-transitory computer readable medium include storing a plurality of intermediate noise states for each of a plurality of candidate prompts, caching a subset of the plurality of intermediate noise states based on frequency of use and computational efficiency of the plurality of intermediate noise states, and retrieving an intermediate noise state from the cached subset of the plurality of intermediate noise states based on a similarity between an input prompt and a candidate prompt corresponding to the intermediate noise state.

An apparatus and method for image generation are described. One or more aspects of the apparatus and method include at least one processor; at least one memory storing instruction executable by the at least one processor, a cache selector configured retrieve an intermediate noise state based on a similarity between the input prompt and a candidate prompt corresponding to the intermediate noise state, and an image generation model comprising parameters stored in the at least one memory and trained to generate a synthetic image based on an input prompt.

### BRIEF DESCRIPTION OF THE DRAWINGS

FIG. 1 shows an example of an image processing system according to aspects of the present disclosure.

FIG. 2 shows an example of an image generation application according to aspects of the present disclosure.

FIG. 3 shows an image processing system according to aspects of the present disclosure.

FIG. 4 shows an example of an image processing apparatus according to aspects of the present disclosure.

FIG. 5 shows an example of a guided diffusion architecture according to aspects of the present disclosure.

FIG. 6 shows examples of an image generation process according to aspects of the present disclosure.

FIG. 7 shows an example of an image processing method according to aspects of the present disclosure.

FIG. 8 shows an example of an image processing method according to aspects of the present disclosure.

FIG. 9 shows examples of generated images according to aspects of the present disclosure.

FIG. 10 shows an example of a computing device according to aspects of the present disclosure.

### DETAILED DESCRIPTION

Aspects of the present disclosure relate to systems and methods for image processing using machine learning. Image generation using machine learning, particularly diffusion models, has gained significant attention due to its ability to create realistic and diverse images based on input prompts. For example, diffusion models learn from large datasets of existing images and generate new images by iteratively denoising random noise. The process of generating images using diffusion models involves a forward diffusion process that gradually adds noise to the input image until the input image becomes pure random noise, and a reverse diffusion process that iteratively denoises the random noise, step by step, to reconstruct the final image.

The quality and diversity of the generated images depend on the number of denoising steps performed during the reverse diffusion process. Each denoising step involves complex mathematical operations and requires significant computational resources. Consequently, there is a trade-off between image quality and computational efficiency in the image generation process using diffusion models. This trade-off can lead to limitations in the quality of the generated images or create difficulties in achieving desired results within practical computational constraints.

For example, generating high-resolution images with fine details may require a large number of denoising steps, resulting in long processing times and high computational costs. On the other hand, reducing the number of denoising steps to improve efficiency may result in images with lower quality, less detail, or more artifacts. This trade-off can be particularly challenging in real-world applications where both image quality and computational efficiency are important factors, such as in interactive systems, real-time rendering, or large-scale image generation tasks.

Embodiments of the present disclosure provide a caching method, apparatus, or system for diffusion models that leverage the similarity between input prompts to reuse intermediate denoising states, effectively reducing the number of denoising steps required for generating new images. The caching method, apparatus, or system can be based on a similarity metric that compares the input prompts with cached prompts and retrieves the most relevant intermediate state from a cache of previously generated images associated with the cached prompts. The caching method, apparatus, and system caches and reuses the intermediate states and enables faster image generation, reducing the computational cost associated with the denoising process.

The caching method, apparatus, or system enables the diffusion model to start the denoising process from an intermediate state that is closer to the desired final image, effectively skipping a significant portion of the computationally expensive denoising steps. The caching method, apparatus, or system leverages the semantic similarity between input prompts and cached prompts, retrieving the most relevant intermediate state from a cache of previously generated images associated with the cached prompts. By reusing intermediate denoising states based on the similarity between input prompts, the invention reduces the number of denoising steps required for generating new images, thereby lowering the computational cost and accelerating the image generation process. As a result, the proposed approach makes image generation using diffusion models more practical for real-world applications and large-scale deployment.

Embodiments of the present disclosure improve the efficiency of image generation using diffusion models while maintaining the quality and diversity of the generated images. For example, a high-quality image can be generated using fewer denoising steps (and therefore, fewer computational resources) by leveraging an intermediate state from a previously generated image with similar attributes. Some embodiments achieve this improved efficiency by generating a set of intermediate denoising states corresponding to a set of input prompts, caching these states based on computational efficiency and frequency of use, and then retrieving the most relevant intermediate state for a new input prompt based on semantic similarity.

### Image Processing System

Accordingly, the present disclosure includes the following aspects. A method for image generation is described. One or more aspects of the method include obtaining an input prompt; retrieving an intermediate noise state based on a similarity between the input prompt and a candidate prompt corresponding to the intermediate noise state; and generating, using an image generation model, a synthetic image based on the input prompt and the intermediate noise state.

Some examples of the method, apparatus, and non-transitory computer readable medium further include encoding the input prompt to obtain a text embedding. Some examples further include comparing the text embedding with a candidate embedding of the candidate prompt, wherein the similarity is determined based on the comparison.

Some examples of the method, apparatus, and non-transitory computer readable medium further include generating a similarity score for each of a plurality of candidate prompts. Some examples further include selecting the candidate prompt having a highest similarity score among the plurality of candidate prompts.

Some examples of the method, apparatus, and non-transitory computer readable medium further include determining an intermediate diffusion step based on the similarity, wherein the intermediate noise state is selected based on the intermediate diffusion step. Some examples of the method, apparatus, and non-transitory computer readable medium further include removing noise from the intermediate noise state using the image generation model based on the intermediate diffusion step.

In some aspects, the intermediate noise state comprises an intermediate output of the image generation model. In some aspects, the intermediate noise state comprises a partially denoised image. In some aspects, the intermediate noise state comprises a partially denoised latent representation.

A method for image generation is described. One or more aspects of the method include storing a plurality of intermediate noise states for each of a plurality of candidate prompts; caching a subset of the plurality of intermediate noise states based on frequency of use and computational efficiency of the plurality of intermediate noise states; and retrieving an intermediate noise state from the cached subset of the plurality of intermediate noise states based on a similarity between an input prompt and a candidate prompt corresponding to the intermediate noise state. Some examples of the method, apparatus, and non-transitory computer readable medium further include generating the plurality of intermediate noise states based on the plurality of candidate prompts using an image generation model.

Some examples of the method, apparatus, and non-transitory computer readable medium further include generating a synthetic image based on the intermediate noise state. Some examples of the method, apparatus, and non-transitory computer readable medium further include detecting a cache miss corresponding to a target prompt of the plurality of candidate prompts. Some examples further include inserting one or more intermediate noise states corresponding to the target prompt based on the cache miss.

Some examples of the method, apparatus, and non-transitory computer readable medium further include computing a cache score for each of the plurality of intermediate noise states based on the frequency of use and computational efficiency. Some examples further include evicting one or more of the plurality of intermediate noise states based on the cache score. In some aspects, the evicted one or more of the plurality of intermediate noise states comprises a subset of the plurality of intermediate noise states corresponding a candidate prompt of the plurality of candidate prompts, and wherein at least one of the plurality of intermediate noise states corresponding to the candidate prompt remains cached after the eviction.

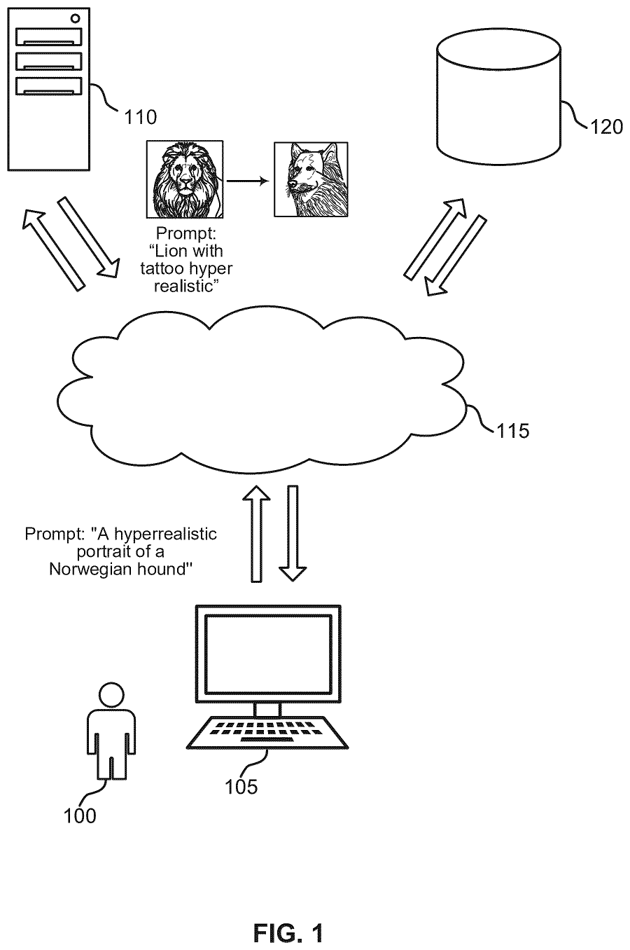

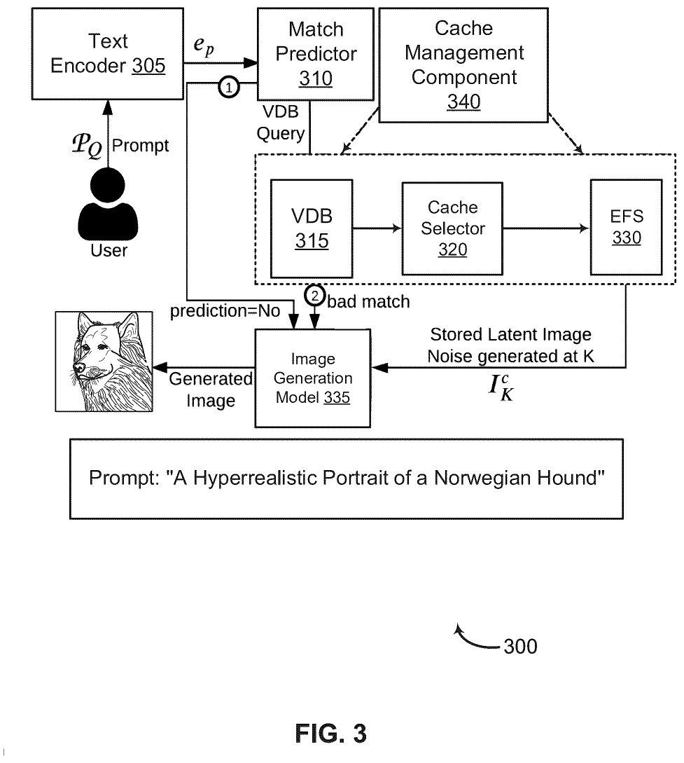

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIGS. 3-4, and 10.

In the example shown in FIG. 1, the user 100 provides a text prompt, such as “a hyper realistic portrait of a Norwegian hound”, to the image processing apparatus 110, e.g., via user device 105 and cloud 115. Image processing apparatus 110 then processes this text prompt to capture the essence of the request. For example, image processing apparatus 110 employs a text encoder to convert the text prompt into an embedding vector that represents the semantic meaning and key features of the desired image.

The image processing apparatus 110 then searches its cache for a similar prompt that has been previously processed. In this example, the cache contains an intermediate noise state corresponding to the prompt “lion with tattoo hyper realistic”. The image processing apparatus 110 uses a match predictor to determine the likelihood of finding a similar intermediate noise state in the cache based on the embedding vector of the input prompt. If a similar prompt is found, the cache selector retrieves the corresponding intermediate noise state.

The image processing apparatus 110 then uses an image generation model to generate a synthetic image based on the input prompt and the retrieved intermediate noise state. The image generation model is a diffusion model that iteratively denoises the intermediate noise state to create a high-quality image that matches the content and style described in the input prompt. By starting from the intermediate noise state, the image generation model can skip some of the initial denoising steps and generate the image more efficiently.

The cache management component of the image processing apparatus 110 maintains and updates the cache of intermediate noise states. It stores the intermediate noise states generated during previous image generation processes and associates them with their corresponding prompts. The cache management component also implements cache replacement policies to ensure that the cache contains the most relevant and frequently accessed intermediate noise states.

In this example, the final output image, which depicts a hyperrealistic portrait of a Norwegian hound, is then returned to the user 100 via cloud 115 and user device 105. This image demonstrates the image processing apparatus 110's capability to transform textual descriptions into high-quality visual content by leveraging cached intermediate noise states to improve efficiency and reduce computational resources.

User device 105 may be a personal computer, laptop computer, mainframe computer, palmtop computer, personal assistant, mobile device, or any other suitable processing apparatus. In some examples, user device 105 includes software that incorporates an image processing application (e.g., query answering, image editing, relationship detection). In some examples, the image editing application on user device 105 may include functions of image processing apparatus 110.

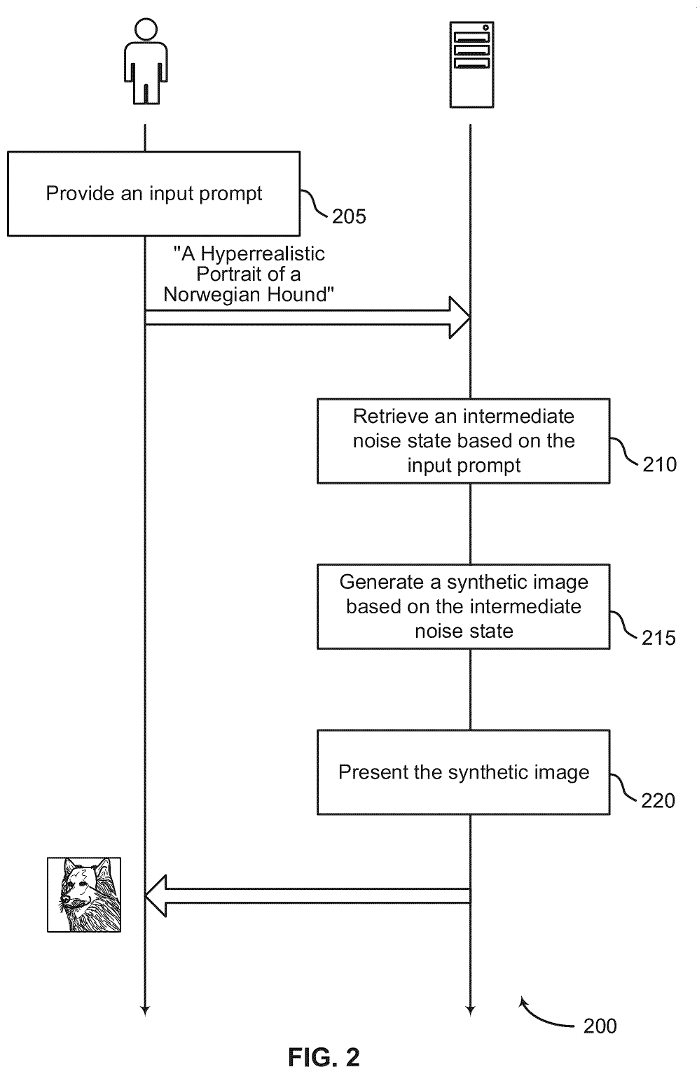

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code that is sent to the user device 105 and rendered locally by a browser. The process of using the image processing apparatus 110 is further described with reference to FIG. 2.

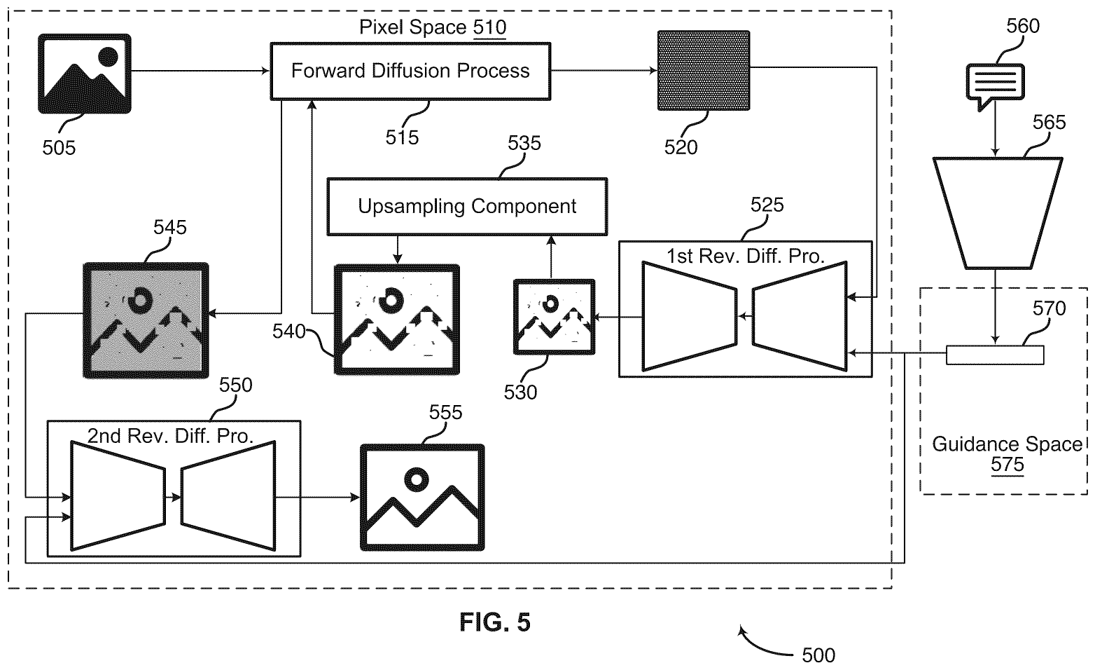

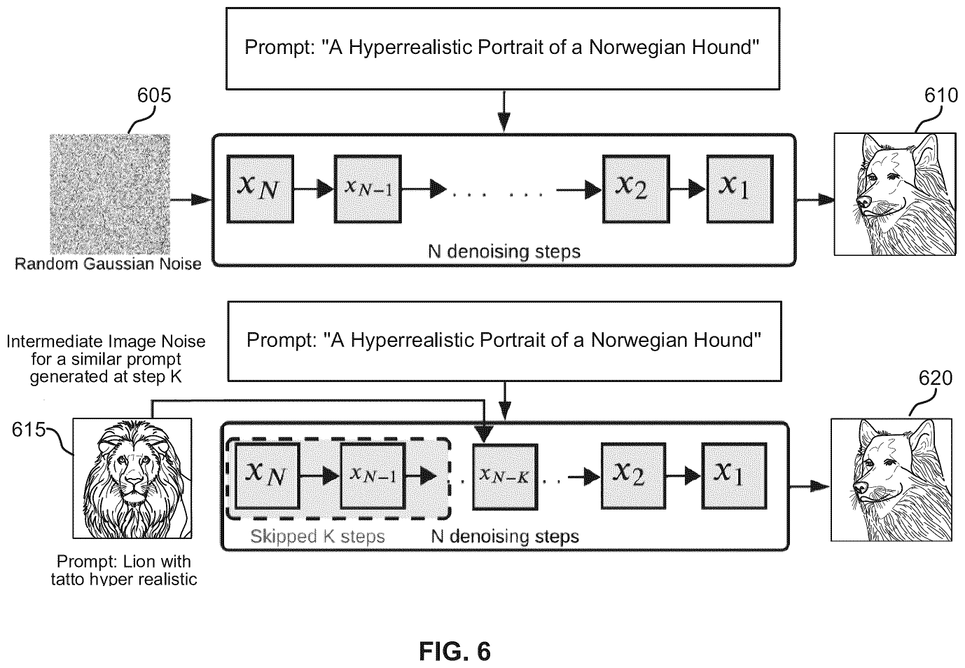

Image processing apparatus 110 includes a computer implemented network comprising an image encoder, a text encoder, a multi-modal encoder, and a decoder. Image processing apparatus 110 may also include a processor unit, a memory unit, an I/O module, and a training component. The training component is used to train a machine learning model (or an image processing network). Additionally, image processing apparatus 110 can communicate with database 120 via cloud 115. In some cases, the architecture of the image processing network is also referred to as a network, a machine learning model, or a network model. Further detail regarding the architecture of image processing apparatus 110 is provided with reference to FIGS. 5-6. Further detail regarding the operation of image processing apparatus 110 is provided with reference to FIGS. 5-6.

In some cases, image processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

FIG. 2 shows an example of an image generation application according to aspects of the present disclosure. The image generation application is an example of, or includes aspects of, the corresponding element described with reference to FIGS. 3-4, and 10.

At operation 205, the user provides an input prompt. In some examples, the input prompt may be a textual description of the desired image content and style. In some cases, the operations of this step are performed by a user as described with reference to FIG. 1. For example, in operation 205, the user begins the image generation process by providing a text prompt such as “a hyperrealistic portrait of a Norwegian hound”. This prompt indicates the specific subject and artistic style to be included in the generated image.

At operation 210, the system retrieves an intermediate noise state based on the input prompt. In some cases, the operations of this step are performed by an image generation apparatus as described with reference to FIGS. 3-4, and 10.

For example, at operation 210, the system processes the input prompt “a hyperrealistic portrait of a Norwegian hound” and searches its cache for a similar prompt. The system finds a cached prompt “lion with tattoo hyper realistic” and retrieves the corresponding intermediate noise state. This intermediate noise state represents a partially denoised version of an image that matches the style and some of the content elements of the input prompt.

At operation 215, the system generates a synthetic image based on the intermediate noise state. In some cases, the operations of this step are performed by an image generation apparatus as described with reference to FIGS. 3-4, and 10.

For example, at operation 215, the system uses an image generation model to iteratively denoise the retrieved intermediate noise state. The image generation model adapts the intermediate noise state to the specific content and style requirements of the input prompt, resulting in a high-quality synthetic image that depicts a hyperrealistic portrait of a Norwegian hound.

At operation 220, the system presents the synthetic image to the user. In some cases, the operations of this step are performed by an image generation apparatus as described with reference to FIGS. 3-4, and 10. For example, at operation 220, the system sends the generated image back to the user via a cloud service and the user's device, as shown in FIG. 1. The user can then view, save, or share the synthetic image that accurately represents their input prompt.

In this example, the image generation process can be completed in a significantly shorter time compared to generating the image from scratch. This improved efficiency allows the user to quickly obtain high-quality results without experiencing excessive waiting times, enhancing the overall user experience and making the image generation process more practical for real-world applications. Moreover, the reduced computational requirements may enable the system to handle a larger number of user requests.

FIG. 3 shows an image processing system 300 according to aspects of the present disclosure. The image processing method or system 300 is an example of, or includes aspects of, the corresponding element described with reference to FIGS. 1-2, 4-6, 9, and 10.

According to some embodiments, the method, apparatus, or system 300 uses approximate caching to reduce computation by retrieving an intermediate state that was created after K^{th} iteration of a prior image generation process. The method, apparatus, or system then reuses and reconditions that retrieved intermediate state for the remaining N-K diffusion steps of the image generation process using a diffusion model.

According to some embodiments, let [symbol] denote the total end-to-end latency of image generation using approximate caching. Within this latency, [symbol] represents the cumulative GPU computation time for N diffusion model steps. The set of possible values for K is denoted as [symbol] . Each search operation in the vector database (VDB) incurs a latency cost denoted as lₛ, and retrieving the intermediate state from the cache introduces a latency denoted as lᵣ. The overall compute savings is denoted as f_{c}.

For prompts effectively utilizing approximate caching, with a cache generated at K, the total latency experienced can be expressed as:

$${l}_{s} + C \cdot \frac{N - K}{N} + {l}_{r} \qquad ( 1 )$$

In comparison, prompts for which the system cannot locate a match in the cache will undergo a total latency of lₛ+C.

According to some embodiments, approximate caching is denoted as h(K) is defined as the likelihood that, when an intermediate state from K^{th} diffusion step is used, it takes at most N-K diffusion steps to generate a faithful reconditioned image where Nis fixed. That is, (1-h(K)) fraction of cache exists, which cannot be reconditioned by running N-K diffusion steps.

At K=0, which indicates running diffusion model from scratch, all historical prompts are theoretically usable since image can be reconditioned in at most N-0 diffusion steps, leading to h(0)=1.0. As K increases, h(K) decreases since only a smaller fraction of intermediate states from K^{th} diffusion step can be used to recondition an image by running diffusion at most N-K diffusion steps. For lower values of K, h(K) is less than 1.0 but can still be relatively high. For example, diffusion models can effectively recondition the retrieved state if the state is from the initial diffusion steps, resulting in the generation of faithful images. Faithful images refer to images that accurately or closely adhere to the intended content, features, or style specified by the input or guiding data.

The decrease in h(K) is influenced by how dissimilar the prompts are. When K surpasses a threshold, denoted as K_{T}, the retrieved state is no longer suitable for further reconditioning, and thus, h(K≥K_{T})=0. Consequently, the effective fraction of savings in GPU computation for a given K can be expressed as

$${f}_{c} = h ( K ) \cdot \frac{K}{N} . \qquad ( 2 )$$

Substantial savings can be achieved when both K and h(K) are sufficiently high. In some cases, the challenge lies in the fact that as K increases, h(K) tends to decrease while aiming to maintain the quality [symbol] of the generated images.

According to some embodiments, hₒₚₜ(K) is defined as the fraction of cache stored at K^{th} diffusion step. For example, with N=50, K=5, hₒₚₜ(K) is the fraction of cache that can be used to recondition an image by running diffusion steps for exact 5 steps. Thus,

$$\begin{matrix}{h}_{opt} ( K ) = h ( K ) - h ( {K}^{′} ) , where {arg min}_{{K}^{′}} ( {K}^{′} > K ) & ( 3 ) \\ h ( min 𝒦 ) = {\sum }_{K ∈ 𝒦} {h}_{opt} ( K ) & ( 4 )\end{matrix}$$

Here, hₒₚₜ(K) quantifies the probability that K represents the maximum potential savings for incoming prompts. h(min [symbol] ) represents the overall hit-rate, i.e., fraction of prompt [symbol] _{Q} having a cache hit.

According to some embodiments, end-to-end latency [symbol] is to be minimized while the quality [symbol] of generated images are maintained. To this end, the method, apparatus, or system may operate under the constraint that reconditioning of image with cache at the selected K values must ensure a specified level of image quality [symbol] compared to when image is generated from scratch. The purpose is to find the optimal K value that satisfied the objectives and the quality constraint below. For a given incoming prompt [symbol] _{Q} and its corresponding cached prompt [symbol] _{c}:

Objective (Minimize [symbol] ): (following Eq. 1)

$${min}_{K} ℒ = {\sum }_{K ∈ 𝒦} ( {l}_{s} + {h}_{opt} ( K ) \cdot {l}_{r} + {h}_{opt} ( K ) \cdot 𝒞 \cdot \frac{N - K}{N} ) \qquad ( 5 )$$

### Quality Constraint:

$$ℚ ( {I}_{K}^{c} \vert {𝒫}_{{c}_{K}} , {𝒫}_{Q} ) > α \cdot ℚ ( {I}_{0} \vert {𝒫}_{Q} ) \qquad ( 6 )$$

Here, I_{K}^{C} represents the image generated by using cache [symbol] at K and then reconditioning for N-K diffusion steps. ∝ε[0,1] represents the tolerance threshold over the quality of images generated and is such that I_{K}^{C} is not much worse than I₀.

According to some embodiments, in one example, during implementation of the method, apparatus, or system, a metric for measuring image quality, such as CLIPScore metric, may be used to define [symbol] . For example, using the CLIPScore metric, [symbol] may be defined with ∝=0.9. However, embodiments of the present disclosure are not limited thereto, and metrics other than CLIPScore may be used to evaluate image quality. In this example, lᵣ, lₛ<< [symbol] , the objective reduces to

$${min}_{K} ℒ = {\sum }_{K ∈ 𝒦} ( {h}_{opt} ( K ) \cdot 𝒞 \cdot \frac{N - K}{N} ) \qquad ( 7 )$$

which maximizes K and hₒₚₜ(K) to obtain minimal latency.

This framework demonstrates the relationship between latency and quality in the context of approximate caching. In some examples, the wasted overhead of the method, apparatus, or system can be captured as (1-(h(K))·lₛ, where the vector database is queried and results in cache miss. This means if the method, apparatus, or system is operated in a setting where h(K) is lower even if K is high, the method, apparatus, or system may not provide latency benefits if lᵣ is compared to GPU compute latency [symbol] and such overhead reduction can be an important design aspect. According to some embodiments, due to disparate cost of high-end GPUs, even if there is not much latency reduction, it can still be significantly cost-effective to use the method, apparatus, or system according to embodiments of the present disclosure, as it cuts expensive GPU compute cost on the cloud. In some examples, lₛ is of the order of 100 ms whereas is of the order of 10 s.

Referring to FIG. 3, the method, apparatus, or system 300 includes generating, using text encoder 305, an embedding vector eₚ, e.g., a text embedding, based on the prompt [symbol] _{Q} provided by a user. A user may be a human user or a machine.

As illustrated n FIG. 3, match predictor 310 predicts whether there is a close match for this embedding in VDB 315. If a close match is found, the system initiates the process of retrieving an intermediate state from the cache. A search query is sent to VDB 315 to find the closest cached embedding of eₚ. The closest cached embedding of eₚ can be denoted as e_{c} Vector database VDB 315 utilizes efficient approximate nearest neighbor search to find such closest embeddings.

In some examples, for a cached historical prompt in VDB 315, the system stores one or more intermediate states during the diffusion process. Cache selector 320 calculates which of these intermediate states corresponding to the match prompt e_{c} is closest to the new prompt vector eₚ using a heuristic. In some examples, using a heuristic includes applying a practical method or approach that is not guaranteed to be perfect or optimal but is sufficient for reaching an immediate or short-term goal or decision. However, embodiments of the present disclosure are not limited thereto.

In some examples, the intermediate state deemed closest is then retrieved from a file storage, such as Elastic File System as Storage (EFS). EFS is a cloud storage service that offers scalable, elastic, and fully managed file storage. However, embodiments of the present disclosure are not limited thereto. Referring to FIG. 3, the intermediate state deemed closest is then retrieved EFS 330. For example, the pointer of the storage location provided by the VDB 315 query result, and the intermediate state number calculated by cache selector 320 may be used to retrieve the intermediate state.

In some examples, an intermediate state I_{K}^{C} is an L×D dimensional latent representation captured during the denoising process of e_{c}, after the K^{th} step. The retrieved intermediate state I_{K}^{C} is then passed to image generation model 335 along with eₚ for reconditioning and image generation for the remaining denoising steps.

In some examples, the system may directly fall back to the vanilla diffusion model to generate an image from scratch, sacrificing any optimization. For example, when match predictor 310 predicts that a close entry in VDB 315 is unlikely, or when the VDB 315 query returns a match e, that is very dissimilar to eₚ.

In some examples, to maintain the cache under a fixed storage size and prevent VDB 315 from arbitrarily growing and storing stale entries, cache management component 340 operates in offline mode. In these examples, cache management component 340 implements the Least Computationally Beneficial and Frequently Used (LCBFU) protocol to keep both the cache VDB entries fresh.

Match predictor 310 predicts whether an embedding close enough to eₚ, which is the embedding vector of the current input prompt, is likely to be present in VDB 315. The purpose of match predictor 310 is to reduce the latency overhead and VDB load associated with searching for a similar cached entry when it is unlikely to be found.

In some examples, match predictor 310 uses a lightweight classifier that runs on the CPU of the same node where the image generation model 335 runs on the GPU. This choice may reduce the classification latency significantly compared to querying VDB 315 directly. Let the latency overhead be (1-(h(K)). lₛ, and let cₚ denote the precision of the classifier, the effective overhead of the method, apparatus, or system 300 is then:

$$1 - max ( h ( K ) , {c}_{p} ) \cdot {l}_{s} , where h ( K ) , {c}_{p} ∈ [ 0 , 1 ] \qquad ( 8 )$$

In some examples, the classifier used by match predictor 310 is a One-Class Support Vector Machine (One-Class SVM), which constructs a decision function for outlier detection. The One-Class SVM is trained using all prompt embeddings stored in VDB 315, assigning them a positive label of 1. To achieve high precision and recall, the model is effectively overfit to the existing prompt embedding space. Additionally, Stochastic Gradient Descent (SGD) is used to enable faster retraining of the classifier when embeddings in VDB 315 change significantly, for example, by more than 5%.

In some examples, if match predictor 310 determines that a close entry in VDB 315 is unlikely, the system bypasses the cache retrieval flow altogether, reducing the wasted overhead. In some examples, when the precision of match predictor 310 is less than 1.0, the system may miss some opportunities for compute savings during false-negative cases, as the system may directly fall back to the vanilla diffusion model and generate the image from scratch instead of attempting to retrieve an intermediate state.

VDB 315 stores the embeddings of historical prompts for fast and efficient similarity search with the embedding of the incoming prompt. VDB 315 uses indexing methods including quantization, graphs, or trees to store and perform high-dimensional similarity search over vectors. For each incoming search with eₚ, VDB 315, which is already populated with the embeddings, returns a payload that points to the path where the corresponding intermediate states of e_{c} at different K values are stored. The system uses cosine similarity as a measure to find the nearest neighbor.

Cache selector 320 determines which intermediate state I_{K}^{C}, corresponding to the K^{th} diffusion step of the closest cached embedding e_{c}, is retrieved from EFS 330 to recondition the intermediate state for the remaining N-K steps with prompt eₚ. In some examples, this selection is made to maximize compute savings while maintaining acceptable image quality. In some examples, cache selector 320 executes the following Algorithm 1:

Algorithm 1 CacheSelector - Profiling ( [symbol] , I_{K}^{c}, α)

| | |
|---|---|
| 1: | for K in [symbol] do |
| 2: | [I_{K}] ← model( [symbol] _{Q}, I_{K}^{c}, K) ∀ [symbol] _{Q} |
| 3: | min_sim ← min{sim s \| ∀I ∈ [I_{K}], quality (I) > α} |
| 4: | sim_K_map [K] ← min_sim |
| 5: | end for |
| 6: | return sim_K_map |

In some examples, cache selector 320 uses an offline profiling algorithm to find the appropriate K value based on the similarity score between the embeddings of the input prompt eₚ and the closest cached prompt e_{c}. The profiling algorithm generates images at each value of K for a set of prompts with their nearest cache prompt and finds the minimum similarity score such that all generated images are above a quality threshold a. This minimum similarity score is then used at runtime to determine the optimal K value for a given similarity score between eₚ and e_{c}.

EFS 330 stores the actual intermediate noise states. In some examples, the size of the files containing the intermediate states depends on the architecture of the image generation model 335. In some embodiments, the system stores intermediate states for 5 distinct values of K: {5, 10, 15, 20, 25}. In some examples, once the appropriate intermediate state I_{K}^{C} is retrieved from EFS 330, image generation model 335 denoises the intermediate state for the remaining N-K steps to generate the final image.

Cache management component 340 is a non-generic component for implementing the LCBFU protocol. In some cases, cache management component 340 manages the storage noises in such a manner that for a given cache storage size, cache management component 340 optimizes the space for the noises that is likely to give the best computational efficiency to method, apparatus, or system 300, according to embodiments of the present disclosure.

In some examples, cache management component 340 is not necessarily a separate component within the image processing system 300. Cache management component 340 may be integrated with or included in other components, such as cache selector 320. In these examples, cache management component 340 retains the role of managing and controlling the data caching process.

In some cases, cache management component 340 works in the background to maintain the entries in the cache storage in EFS 330 and in VDB 315. By implementing the LCBFU protocol, cache management component 340 is customized for approximate caching in image generation model 335.

For example, cache management component 340 takes into account both the access frequency of items and the potential compute benefit in case of a cache hit. Cache management component 340 evicts items with the least LCBFU-score, which is calculated for each item i as: fᵢ×Kᵢ, where fᵢ is the access frequency of item i, and Kᵢ denotes the diffusion denoising step to which this intermediate state belongs.

In some examples, cache management component 340 performs an insertion. With a cache miss, the intermediate states generated at diffusion denoising step K∈ [symbol] are inserted into the cache storage, and the corresponding embedding of the prompt is inserted into VDB 315. In these examples, |K| intermediate states are stored in the cache storage per prompt. Insertions are performed without any eviction until the target storage limit is reached, after which an insertion is preceded by an eviction.

In some examples, cache management component 340 performs an eviction. Cache management component 340 maintains a running list of LCBFU-scores in a K-min heap and evicts the top-|K| items from the heap root just before inserting |K| intermediate states for a new prompt. In some examples, cache management component 340 evicts image noises that contribute least to compute savings.

In some examples, cache management component 340 may come across cases where noises at some K values are evicted while noises at some other values are still in the cache, creating holes in the stored intermediate states. The method, apparatus, or system 300 may handle these situations by choosing the intermediate state with the largest value of K that is less than or equal to the optimal K determined by cache selector 320. This ensures that the system continues to generate high-quality images, albeit with a slight sacrifice in potential compute savings when encountering holes. According to some embodiments, for example, such cases arise only in 4-5% of the prompts, resulting in imperceptible performance degradation.

In some examples, the intermediate states corresponding to all the |K| values for a prompt may turn into holes. Cache management component 340 then marks that prompt embedding as dirty and removes it from VDB 315 as well as the corresponding metadata from the cache storage.

In some examples, cache management component 340 performs both insertions and deletions on VDB 315 in batches. In these examples, the classifier in match predictor 310 is retrained with the fresh entries in VDB 315. For example, both VDB 315 updates and classifier updates can be fast, taking around 7.5 and 0.04 seconds, respectively, for 10,000 records.

### Image Processing Apparatus

An apparatus for image generation is described. One or more aspects of the apparatus include at least one processor; at least one memory storing instruction executable by the at least one processor; a cache selector configured retrieve an intermediate noise state based on a similarity between the input prompt and a candidate prompt corresponding to the intermediate noise state; and an image generation model comprising parameters stored in the at least one memory and trained to generate a synthetic image based on an input prompt.

Some examples of the apparatus and method further include a match predictor configured to determine whether to retrieve the intermediate noise state. Some examples of the apparatus and method further include a text encoder configured to encode the input prompt to obtain a text embedding. Some examples of the apparatus and method further include a vector database configured to store text embeddings for the input prompt and the candidate prompt.

In some aspects, the image generation model comprises a diffusion model. Some examples of the apparatus and method further include a database configured to store the intermediate noise state, wherein the database comprises a cache based on frequency of use and computational efficiency.

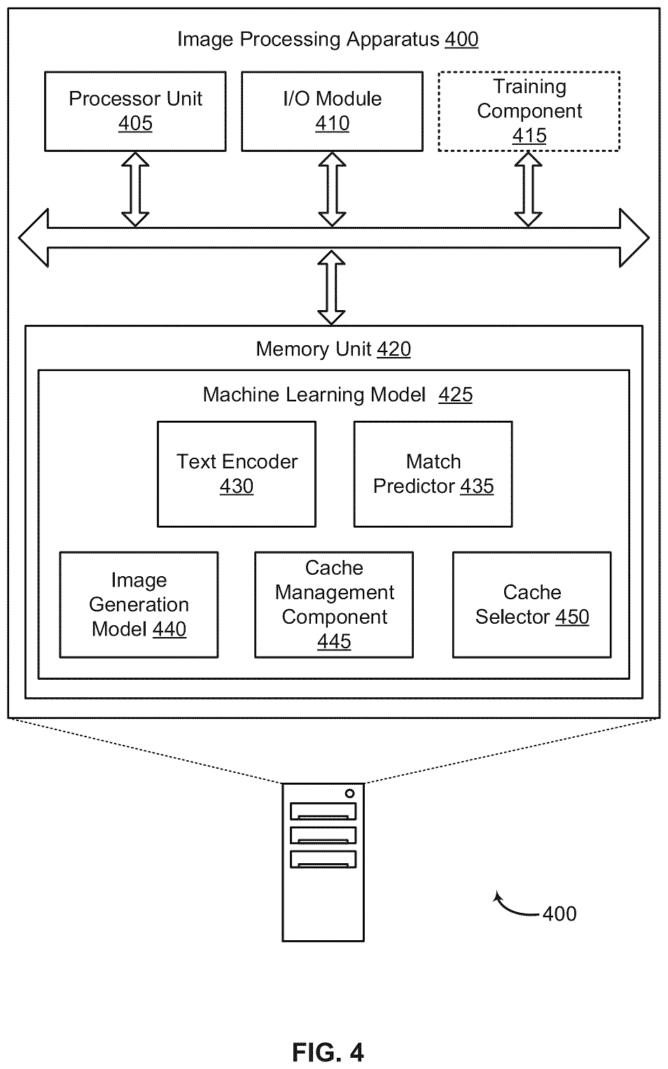

FIG. 4 shows an example of an image processing apparatus 400 according to embodiments of the present disclosure. The image processing apparatus 400 is an example of, or includes aspects of, the corresponding element described with reference to FIGS. 1-3, 5-10.

Referring to FIG. 4, the image generation apparatus includes a text encoder 430, a match predictor 435, an image generation model 440, a cache management component 445, and a cache selector 450. These components work together to generate synthetic images based on input prompts while leveraging cached intermediate noise states to improve efficiency and reduce computational resources.

The text encoder 430 processes input prompts and converts them into embedding vectors that capture the semantic meaning and key features of the desired image. This component allows users to describe the content and style of the image they want to generate using natural language descriptions. The text encoder 430 uses techniques such as tokenization, word embedding, and neural networks to transform the input prompts into a format that can be understood by the image generation model 440.

The match predictor 435 predicts the likelihood of finding a similar intermediate noise state in the cache based on the embedding vector of the input prompt. This component helps to avoid unnecessary cache searches when the input prompt is significantly different from the candidate prompts in the cache. The match predictor 435 uses machine learning algorithms, such as classification or similarity threshold models, to make its predictions and improve the efficiency of the cache retrieval process.

The image generation model 440 generates synthetic images based on the input prompts and the retrieved intermediate noise states. This component uses a diffusion model, which iteratively denoises a random noise input to create a high-quality image that matches the content and style described in the input prompt. The image generation model 440 can start the denoising process from scratch or from an intermediate noise state retrieved from the cache, depending on the similarity between the input prompt and the candidate prompts.

The cache management component 445 maintains and updates the cache of intermediate noise states. This component stores the intermediate noise states generated during previous image generation processes and associates them with their corresponding candidate prompts. The cache management component 445 also implements cache replacement policies, such as Least Recently Used (LRU) or Least Frequently Used (LFU), to ensure that the cache contains the most relevant and frequently accessed intermediate noise states while staying within the allocated storage capacity.

The cache selector 450 determines which intermediate noise state to retrieve from the cache based on the similarity between the input prompt and the candidate prompts. This component calculates the similarity scores between the embedding vector of the input prompt and the embedding vectors of the candidate prompts using distance metrics, such as cosine similarity or Euclidean distance. The cache selector 450 then retrieves the intermediate noise state corresponding to the candidate prompt with the highest similarity score, provided that the score is above a predefined threshold. If no suitable intermediate noise state is found in the cache, the cache selector 450 informs the image generation model 440 to generate the image from scratch.

FIG. 5 shows an example of a guided diffusion architecture 500 according to aspects of the present disclosure. Diffusion models are a class of generative ANNs that can be trained to generate new data with features similar to features found in training data. In particular, diffusion models can be used to generate novel images. Diffusion models can be used for various image generation tasks, including image super-resolution, generation of images with perceptual metrics, conditional generation (e.g., generation based on text guidance), image inpainting, and image manipulation.

Diffusion models function by iteratively adding noise to data during a forward diffusion process and then learning to recover the data by denoising the data during a reverse diffusion process. Examples of diffusion models include Denoising Diffusion Probabilistic Models (DDPMs) and Denoising Diffusion Implicit Models (DDIMs). In DDPMs, a generative process includes reversing a stochastic Markov diffusion process. On the other hand, DDIMs use a deterministic process so that a same input results in a same output. Diffusion models may also be characterized by whether noise is added to an image itself, as in pixel diffusion, or to image features generated by an encoder, as in latent diffusion.

For example, according to some aspects, forward diffusion process 515 gradually adds noise to original image 505 to obtain noise images 520 at various noise levels. In some cases, forward diffusion process 515 is implemented by a forward diffusion component.

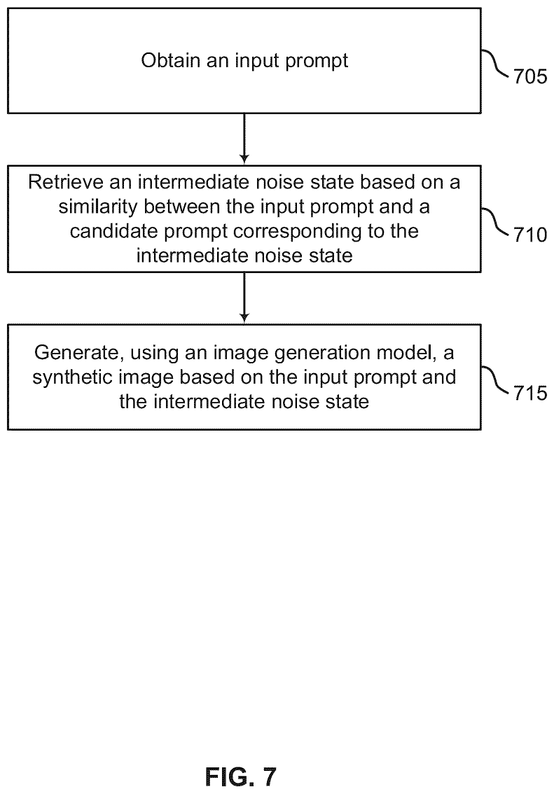

According to some aspects, first reverse diffusion process 525 gradually removes the noise from noise images 520 at the various noise levels at various diffusion steps to obtain predicted denoised image 530. In some cases, a predicted denoised image 530 is created from each of the various noise levels. For example, in some cases, at each diffusion step of first reverse diffusion process 525, a first diffusion model (such as the first diffusion model described with reference to FIG. 7) makes a prediction of a partially denoised image, where the partially denoised image is a combination of a predicted denoised image (e.g., a predicted final output) and noise for that diffusion step. Therefore, in some cases, each predicted denoised image can be thought of as the first diffusion model's prediction of a final noiseless output at each diffusion step, and each predicted denoised image 530 can therefore be thought of as an “early” prediction of a final output at a respective diffusion step of first reverse diffusion process 525.

According to some aspects, a predicted denoised image 530 is provided to upsampling component 535 (such as the upsampling component described with reference to FIG. 7). In some cases, upsampling component 535 upsamples the predicted denoised image 530 to output upsampled denoised image 540 at a higher resolution. In some cases, forward diffusion process 515 gradually adds isotropic noise to upsampled denoised image 540 at various noise levels to obtain intermediate input images 545. In some cases, an intermediate input image 545 can be thought of as an upscaled version of the partially denoised image at the time step of first reverse diffusion process 525 corresponding to the predicted denoised image 530, where the intermediate input image 545 includes a Gaussian distribution of noise.

According to some aspects, second reverse diffusion process 550 gradually removes noise from intermediate noise images 545 to obtain output image 555 at the higher resolution. In some cases, an output image 555 is created from each of the various noise levels.

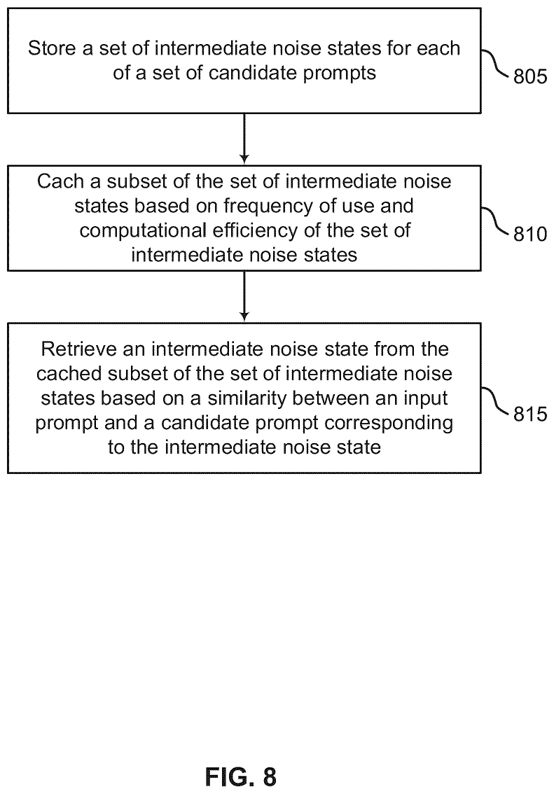

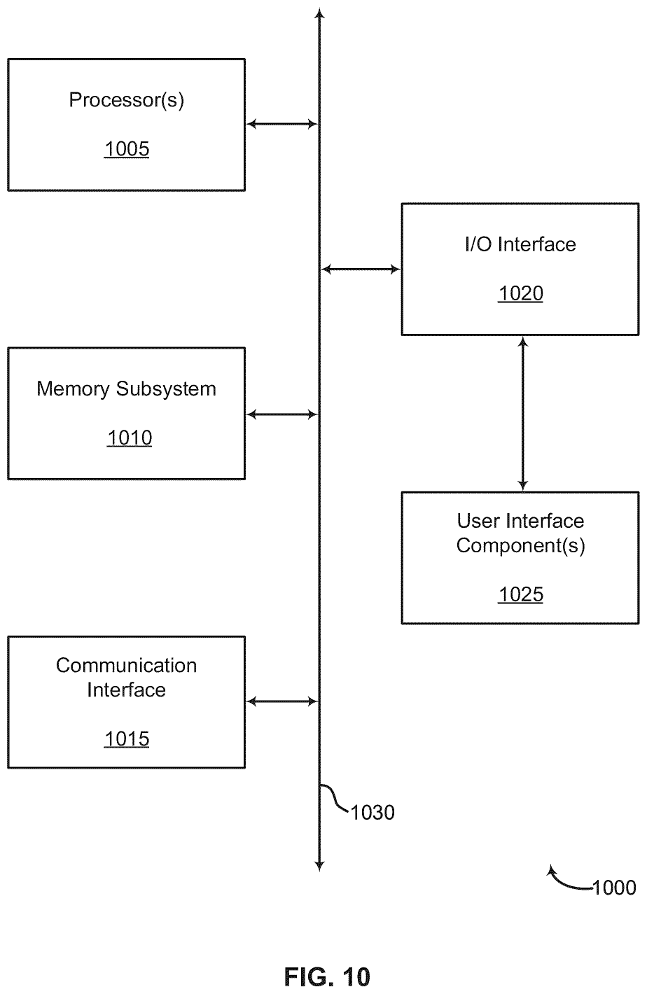

In some cases, each of first reverse diffusion process 525 and second reverse diffusion process 550 are implemented via a U-Net ANN (such as the U-Net architecture described with reference to FIG. 8). Forward diffusion process 515, first reverse diffusion process 525, and second reverse diffusion process 550 are examples of, or include aspects of, the corresponding elements described with reference to FIG. 10.

In some cases, each of first reverse diffusion process 525 and second reverse diffusion process 550 are guided based on a prompt 560, such as a text prompt, an image, a layout, a segmentation map, etc. Prompt 560 can be encoded using encoder 565 (in some cases, a multi-modal encoder) to obtain guidance features 880 (e.g., a prompt embedding) in guidance space 885.

According to some aspects, guidance features 885 are respectively combined with noise images 520 and intermediate input images 545 at one or more layers of first reverse diffusion process 520 and second reverse diffusion process 550 to guide predicted denoised image 530 and output image 555 towards including content described by prompt 560. For example, guidance features 880 can be respectively combined with noise images 520 and intermediate input images 545 using cross-attention blocks within first reverse diffusion process 525 and second reverse diffusion process 550. In some cases, guidance features 880 can be weighted so that guidance features 880 have a greater or lesser representation in predicted denoised image 530 and output image 555.

Cross-attention, also known as multi-head attention, is an extension of the attention mechanism used in some ANNs for NLP tasks. In some cases, cross-attention enables each of first reverse diffusion process 525 and second reverse diffusion process 550 to attend to multiple parts of an input sequence simultaneously, capturing interactions and dependencies between different elements. In cross-attention, there are typically two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring a similarity between each query representation and the key representations, where a higher similarity indicates that more attention is given to a key element. An attention score indicates an importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing each of first reverse diffusion process 525 and second reverse diffusion process 550 to better understand the context and generate more accurate and contextually relevant outputs.

As shown in FIG. 5, guided diffusion architecture 500 is implemented according to a pixel diffusion model. According to some aspects, guided diffusion architecture 500 is implemented according to a latent diffusion model. In a latent diffusion model, forward and reverse diffusion processes occur in a latent space, rather than a pixel space.

For example, in some cases, an image encoder encodes original image 505 as image features in a latent space. In some cases, forward diffusion process 515 adds noise to the image features, rather than original image 505, to obtain noisy image features. In some cases, first reverse diffusion process 525 gradually removes noise from the noisy image features (in some cases, guided by guidance features 880) to obtain predicted denoised image features at an intermediate step of first reverse diffusion process 525. In some cases, an upsampling component upsamples the predicted denoised image features to obtain upsampled image features. In some cases, forward diffusion process 515 gradually adds noise to the upsampled image features to obtain intermediate image features. In some cases, second reverse diffusion process 550 gradually removes noise from the intermediate image features to obtain output image features.

In some cases, an image decoder decodes the output image features to obtain output image 555 in pixel space 510. In some cases, as a size of image features in a latent space can be significantly smaller than a resolution of an image in a pixel space (e.g., 32, 64, etc. versus 256, 512, etc.), encoding original image 505 to obtain the image features can reduce inference time by a large amount.

FIG. 6 shows examples of image generation process according to aspects of the present disclosure. The image generation process is an example of, or includes aspects of, the corresponding element described with reference to FIGS. 1-5, and 9-10.

According to embodiments of the present disclosure, the system uses prompt 615 as the input. For example, prompt 615 is “a hyperrealistic portrait of a Norwegian hound.” The system finds a prompt in the cache that is closest to prompt 615. In this example, the prompt in the cache is “lion with tattoo hyper realistic.” The system then retrieves the intermediate state corresponding to the prompt in the cache and generates second image 620 based on the intermediate state. The generated second image 620 depicts a hyperrealistic portrait of a Norwegian hound.

An image generation model including a diffusion model is used to generate second image 620. The image generation model is an example of, or includes aspects of, the corresponding element described with reference to FIG. 3. By utilizing an intermediate state from a previous image generation process that used the prompt “lion with tattoo hyper realistic,” which is similar to prompt 615, the method allows the image generation model to skip K steps of the N denoising diffusion steps when generating second image 620.

In comparison, in another process, random Gaussian noise 605 is used as the input to the same image generation model. The image generation model performs N denoising diffusion steps on random Gaussian noise 605 to generate first image 610. In this example, the generated first image 610 depicts a hyperrealistic portrait of a Norwegian hound that is substantially similar to or the same as the second image 620.

FIG. 7 shows an example of image processing method 700 for according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system obtains an input prompt. In some cases, the operations of this step refer to, or may be performed by, a text encoder as described with reference to FIGS. 3-4, and 10.

For example, obtaining the input prompt may involve receiving a text description from a user, such as “a hyperrealistic portrait of a Norwegian hound” or “a woman in Hijab with Sweatshirt on the table with cats anime style.” The text encoder processes the input prompt to generate an embedding vector that captures the semantic meaning and key features of the desired image. The system may also include a user interface that allows users to enter their own prompts or select from a library of predefined options.

At operation 710, the system retrieves an intermediate noise state based on a similarity between the input prompt and a candidate prompt corresponding to the intermediate noise state. In some cases, the operations of this step refer to, or may be performed by, an image generation model as described with reference to FIGS. 3-4, and 10.

For example, retrieving the intermediate noise state may involve comparing the embedding vector of the input prompt with the embedding vectors of candidate prompts stored in a vector database. The system identifies the candidate prompt that has the highest similarity score with the input prompt and retrieves the corresponding intermediate noise state. The intermediate noise state represents a partially denoised version of the image generated from the candidate prompt at a specific diffusion step, such as K=15 or K=20. By using the intermediate noise state, the system can skip the initial denoising steps and save computational resources and time.

At operation 715, the system generates, using an image generation model, a synthetic image based on the input prompt and the intermediate noise state. In some cases, the operations of this step refer to, or may be performed by, an image generation model as described with reference to FIGS. 3-4, and 10.

For example, generating the synthetic image may involve feeding the intermediate noise state and the embedding vector of the input prompt into the image generation model. The model then performs the remaining denoising diffusion steps, starting from the intermediate noise state, to generate the final synthetic image. The model adapts the intermediate noise state to the specific details and requirements of the input prompt, refining the image to match the desired content and style. The resulting synthetic image accurately captures the intended scene or object described in the input prompt, such as a hyperrealistic portrait of a Norwegian hound or an anime-style illustration of a woman in a Hijab with cats on a table.

FIG. 8 shows an example of image processing method 800 according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system stores a set of intermediate noise states for each of a set of candidate prompts. In some cases, the operations of this step refer to, or may be performed by, a database as described with reference to FIGS. 3-4, and 10.

For example, storing the intermediate noise states may involve generating images for a large set of candidate prompts using a diffusion model. During the denoising process, the system captures and stores the intermediate noise states at different diffusion steps, such as K=5, K=10, K=15, K=20, and K=25. These intermediate noise states represent partially denoised versions of the generated images and can be used as starting points for generating new images with similar prompts. The system may also include a mechanism to periodically update the set of candidate prompts and their corresponding intermediate noise states based on user feedback or changes in the application domain.

At operation 810, the system caches a subset of the set of intermediate noise states based on frequency of use and computational efficiency of the set of intermediate noise states. In some cases, the operations of this step refer to, or may be performed by, a cache selector as described with reference to FIGS. 3-4, and 10.

For example, caching the subset of intermediate noise states may involve analyzing the usage patterns and computational benefits of each intermediate noise state. The system keeps track of how often each intermediate noise state is retrieved and used for generating new images, as well as the amount of computational resources and time saved by using that intermediate noise state instead of starting from scratch. Based on this information, the cache selector identifies the most frequently used and computationally efficient intermediate noise states and stores them in a cache memory for faster access. The system may also employ a cache replacement policy, such as Least Recently Used (LRU) or Least Frequently Used (LFU), to manage the cache contents and ensure optimal performance.

At operation 815, the system retrieves an intermediate noise state from the cached subset of the set of intermediate noise states based on a similarity between an input prompt and a candidate prompt corresponding to the intermediate noise state. In some cases, the operations of this step refer to, or may be performed by, an image generation model as described with reference to FIGS. 3-4, and 10.

For example, retrieving the intermediate noise state may involve comparing the embedding vector of the input prompt with the embedding vectors of the candidate prompts associated with the cached intermediate noise states. The system calculates the similarity scores between the input prompt and the candidate prompts using a distance metric, such as cosine similarity or Euclidean distance. The candidate prompt with the highest similarity score is considered the best match for the input prompt, and its corresponding intermediate noise state is retrieved from the cache. If the similarity score is above a predefined threshold, the system uses the retrieved intermediate noise state as the starting point for generating the new image. Otherwise, the system may fall back to generating the image from scratch or using a less similar intermediate noise state.

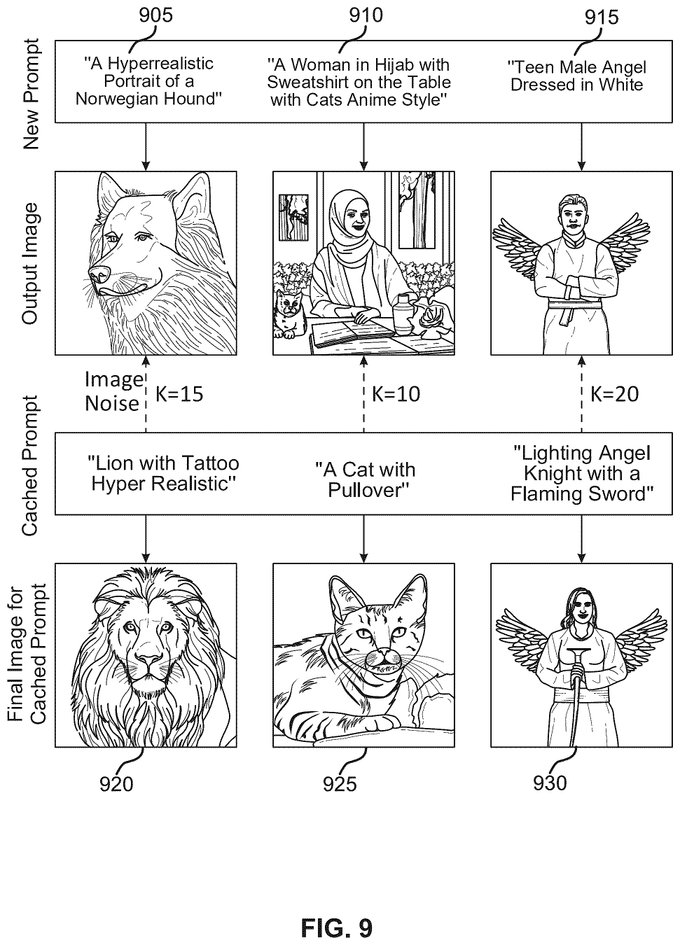

FIG. 9 shows examples of generated images according to aspects of the present disclosure. The generated images are examples of, or include aspects of, the corresponding elements described with reference to FIGS. 1-6, and 10.

In FIG. 9, first prompt 905 is “a hyperrealistic portrait of a Norwegian hound.” The system retrieves an intermediate state corresponding to a cached prompt “lion with tattoo hyper realistic” at diffusion step K=15. First image 920 depicts the image generated from the cached prompt, which is a lion with a tattoo in a hyperrealistic style. The system then uses the retrieved intermediate state and first prompt 905 to generate a synthetic output image that depicts a hyperrealistic portrait of a Norwegian hound.

Second prompt 910 is “a woman in Hijab with Sweatshirt on the table with cats anime style.” The system retrieves an intermediate state corresponding to a cached prompt “a cat with pullover” at diffusion step K=10. Second image 925 depicts the image generated from the cached prompt, which is a cat wearing a pullover. The system then uses the retrieved intermediate state and second prompt 910 to generate a synthetic output image that depicts a woman in a Hijab with a sweatshirt on a table with cats in an anime style.

Third prompt 915 is “teen male angel dressed in white.” The system retrieves an intermediate state corresponding to a cached prompt “lighting angel knight with a flaming sword” at diffusion step K=20. Third image 930 depicts the image generated from the cached prompt, which is a lighting angel knight with a flaming sword. The system then uses the retrieved intermediate state and third prompt 915 to generate a synthetic output image that depicts a teen male angel dressed in white.

The examples in FIG. 9 demonstrate the effectiveness of the method, apparatus, or system according to embodiments of the present disclosure. By retrieving intermediate states corresponding to cached prompts that are similar to the input prompts, the system can generate high-quality synthetic images that closely match the content of the input prompts while saving computational resources and time. The retrieved intermediate states provide a strong foundation for generating the desired images, as they already contain relevant visual features and structures. This allows the image generation model to focus on refining and adapting the intermediate states to the specific details of the input prompts, resulting in synthetic images that accurately capture the intended content and style. The method, apparatus, or system demonstrates its ability to handle a diverse range of prompts, from hyperrealistic portraits to anime-style illustrations, demonstrating the versatility and robustness in generating high-quality images across different domains.

FIG. 10 shows an example of a computing device 1000 according to aspects of the present disclosure, computing device 1000 includes processor(s) 1005, memory subsystem 1010, communication interface 1015, I/O interface 1020, user interface component(s) 1025, and channel 1030. The computing device 1000 is an example of, or includes aspects of, the corresponding element described with reference to FIGS. 1-6, and 9.

In some embodiments, computing device 1000 is an example of, or includes aspects of, the image generation apparatus described with reference to FIGS. 1 and 5. In some embodiments, computing device 1000 includes one or more processors 1005 that can execute instructions stored in memory subsystem 1010 to generate synthetic images comprising a first attribute and a second attribute by providing a first attribute token to a first set layers of the image generation model during a first set of time-steps and providing a second attribute token to a second set of layers of the image generation model during a second set of time-steps

According to some aspects, computing device 1000 includes one or more processors 1005. Processor(s) 1005 are an example of, or includes aspects of, the processor unit as described with reference to FIG. 5. In some cases, a processor is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof.

In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special-purpose components for modem processing, baseband processing, digital signal processing, or transmission processing.

According to some aspects, memory subsystem 1010 includes one or more memory devices. Memory subsystem 1010 is an example of, or includes aspects of, the memory unit as described with reference to FIG. 5. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1015 operates at a boundary between communicating entities (such as computing device 1000, one or more user devices, a cloud, and one or more databases) and channel 1030 and can record and process communications. In some cases, communication interface 1015 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1020 is controlled by an I/O controller to manage input and output signals for computing device 1000. In some cases, I/O interface 1020 manages peripherals not integrated into computing device 1000. In some cases, I/O interface 1020 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1020 or via hardware components controlled by the I/O controller.

According to some aspects, user interface component 1025 enables a user to interact with computing device 1000. In some cases, user interface component 1025 includes an audio device, such as an external speaker system, an external display device such as a display screen, an input device (e.g., a remote-control device interfaced with a user interface directly or through the I/O controller), or a combination thereof. In some cases, user interface component 1025 includes a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input prompt;
retrieving an intermediate noise state based on a similarity between the input prompt and a candidate prompt corresponding to the intermediate noise state; and
generating, using an image generation model, a synthetic image based on the input prompt and the intermediate noise state.

2. The method of claim 1, wherein retrieving the intermediate noise state comprises:
encoding the input prompt to obtain a text embedding; and
comparing the text embedding with a candidate embedding of the candidate prompt, wherein the similarity is determined based on the comparison.

3. The method of claim 1, wherein retrieving the intermediate noise state comprises:
generating a similarity score for each of a plurality of candidate prompts; and
selecting the candidate prompt having a highest similarity score among the plurality of candidate prompts.

4. The method of claim 1, further comprising:
determining an intermediate diffusion step based on the similarity, wherein the intermediate noise state is selected based on the intermediate diffusion step.

5. The method of claim 4, where generating the synthetic image comprises:
removing noise from the intermediate noise state using the image generation model based on the intermediate diffusion step.

6. The method of claim 1, wherein:
the intermediate noise state comprises an intermediate output of the image generation model.

7. The method of claim 1, wherein:
the intermediate noise state comprises a partially denoised image.

8. The method of claim 1, wherein:
the intermediate noise state comprises a partially denoised latent representation.

9. A method comprising:
storing a plurality of intermediate noise states for each of a plurality of candidate prompts;
caching a subset of the plurality of intermediate noise states based on frequency of use and computational efficiency of the plurality of intermediate noise states; and
retrieving an intermediate noise state from the cached subset of the plurality of intermediate noise states based on a similarity between an input prompt and a candidate prompt corresponding to the intermediate noise state.

10. The method of claim 9, further comprising:
generating the plurality of intermediate noise states based on the plurality of candidate prompts using an image generation model.

11. The method of claim 9, further comprising:
generating a synthetic image based on the intermediate noise state.

12. The method of claim 9, further comprising:
detecting a cache miss corresponding to a target prompt of the plurality of candidate prompts; and
inserting one or more intermediate noise states corresponding to the target prompt based on the cache miss.

13. The method of claim 12, further comprising:
computing a cache score for each of the plurality of intermediate noise states based on the frequency of use and computational efficiency; and
evicting one or more of the plurality of intermediate noise states based on the cache score.

14. The method of claim 13, wherein:
the evicted one or more of the plurality of intermediate noise states comprises a subset of the plurality of intermediate noise states corresponding a candidate prompt of the plurality of candidate prompts, and wherein at least one of the plurality of intermediate noise states corresponding to the candidate prompt remains cached after the eviction.

15. An apparatus comprising:
at least one processor;
at least one memory storing instruction executable by the at least one processor;
a cache selector configured retrieve an intermediate noise state based on a similarity between an input prompt and a candidate prompt corresponding to the intermediate noise state; and
an image generation model comprising parameters stored in the at least one memory and trained to generate a synthetic image based on an input prompt.

16. The apparatus of claim 15, further comprising:
a match predictor configured to determine whether to retrieve the intermediate noise state.

17. The apparatus of claim 15, further comprising:
a text encoder configured to encode the input prompt to obtain a text embedding.

18. The apparatus of claim 15, further comprising:
a vector database configured to store text embeddings for the input prompt and the candidate prompt.

19. The apparatus of claim 15, wherein:
the image generation model comprises a diffusion model.

20. The apparatus of claim 15, further comprising:
a database configured to store the intermediate noise state, wherein the database comprises a cache based on frequency of use and computational efficiency.
